(19) United States
(12) Patent Application Publication
(10) Pub. No.: US 2014/0281163 A1
(43) Pub. Date: Sep. 18, 2014

(54) MEMORY SYSTEM

(71) Applicant: KABUSHIKI KAISHA TOSHIBA, Minato-ku (JP)

(72) Inventors: Shigeaki KAWAMURA, Yokohama-shi (JP); Shinji Kawano, Kawasaki-shi (JP)

(73) Assignee: KABUSHIKI KAISHA TOSHIBA, Minato-ku (JP)

(21) Appl. No.: 14/017,705

(22) Filed: Sep. 4, 2013

Related U.S. Application Data
(60) Provisional application No. 61/792,787, filed on Mar. 15, 2013.

(51) Int. Cl. G06F 12/10; G06F 12/02

(52) U.S. Cl. CPC G06F 12/10; G06F 12/0246
USPC 711/103; 711/207

(57) ABSTRACT

According to one embodiment, a memory system includes a plurality of nonvolatile semiconductor memories configured to hold data, or a conversion table for converting a logical address of the data into a physical address of the data, a table memory configured to hold the conversion table, an interface configured to exchange data and a table with the plurality of nonvolatile semiconductor memories based on a command issue request.

### CROSS-REFERENCE TO RELATED APPLICATIONS

This application claims the benefit of U.S. Provisional Application No. 61/792,787, filed Mar. 15, 2013, the entire contents of which are incorporated herein by reference.

### FIELD

Embodiments described herein relate generally to a high-quality memory system.

### BACKGROUND

Recently, a flash memory device as a nonvolatile semiconductor memory system is widely used as an external memory of a host device such as a digital camera and a boot memory system of a computer system, because the flash memory device is electrically programmable and capable of holding data even when the power supply is shut down.

### BRIEF DESCRIPTION OF THE DRAWINGS

FIG. 1 is a view schematically showing the basic configuration of a memory system according to an embodiment;

FIG. 2 is a block diagram schematically showing the basic arrangement of a NAND flash memory chip according to the embodiment;

FIG. 3 is an exemplary circuit diagram showing a memory according to the embodiment;

FIG. 4 is an exemplary view showing the arrangement of a memory space according to the embodiment;

FIG. 5 is a flowchart showing the operation of the memory system when a host device successively reads out a plurality of data from chips; and

FIG. 6 is a sequence diagram showing the relationship between the host device, memory system, and chips.

### DETAILED DESCRIPTION

In general, according to one embodiment, a memory system includes a plurality of nonvolatile semiconductor memories configured to hold data, or a conversion table for converting a logical address of the data into a physical address of the data,

a table memory configured to hold the conversion table,

an interface configured to exchange data and a table with the plurality of nonvolatile semiconductor memories based on a command issue request, and

a controller configured to determine, when a logical address is supplied from a host device, whether the logical address is set in the conversion table held in the table memory,

specify another conversion table in which the logical address is set, if the logical address is not set in the conversion table,

request the interface to issue a command for reading out the specified other conversion table, to the nonvolatile semiconductor memory,

read out the other conversion table, and update the conversion table in the table memory to the other conversion table,

convert the logical address into a physical address based on the conversion table held in the table memory, if the logical address is set in the conversion table, or if the conversion table in the table memory is updated to the other conversion table,

request the interface to issue a command for reading out data held at the physical address, to the nonvolatile semiconductor memory corresponding to the physical address, and

determine, if a logical address for which no read command issue is requested exists among logical addresses supplied from the host device, whether the logical address is set in the conversion table held in the table memory, even while the interface is issuing a command for reading out the data or the conversion table from the nonvolatile semiconductor memory.

Details of the embodiment will be explained below with reference the accompanying drawings. Note that in the following explanation, the same reference numerals denote constituent elements having almost the same functions and arrangements, and a repetitive explanation will be made only when necessary. Note also that each embodiment to be explained below exemplarily discloses an apparatus and/or method for embodying the technical idea of the present invention, and the technical idea of the embodiment does not specify the materials, shapes, structures, layouts, and the like of components to those described below. The technical idea of the embodiment can variously be changed within the scope of the appended claims.

### Embodiment

### Configuration of Memory System

An outline of the basic configuration of a memory system 100 according to this embodiment will be explained below with reference to FIG. 1.

As shown in FIG. 1, a memory system 100 includes a memory controller (to be also simply referred to as a controller) 100a, and a plurality of NAND flash memory chips (to be also referred to as NAND flashes, NAND memories, NAND chips, flash memories, memory chips, or chips) 110. Note that this embodiment includes n+1 (n is an integer of 1 or more) NAND flash memory chips (chips 0 to n) as an example. When it is unnecessary to distinguish between the NAND flash memory chips, they will simply be referred to as chips or the NAND flash memory chips 110. When it is necessary to distinguish between the NAND flash memory chips 110, they will be referred to as chips 0 to n.

Also, this embodiment will be explained by using the NAND flash memory chips, but the present embodiment is not necessarily limited to this.

A host device 200 controls the memory system 100 by issuing, e.g., a command (i.e., a command normalized by an SD memory card, and a command issued by the host device 200 will also be referred to as a host command) to the memory system 100. Also, the memory controller 100a controls the NAND flash memory chips 110 by issuing a NAND interface command (to be referred to as a NAND command or the like) to the NAND flash memory chips 110.

The memory controller 100a includes a host interface (host I/F) 101, a memory buffer 102, a CPU (Central Processing Unit) 103, a bus 104, a volatile instruction memory 105 and a firmware table memory (to be also referred to as an FW table memory hereinafter) 106 (when it is unnecessary to distinguish between the instruction table memory 105 and FW table memory 106, they will simply be called volatile memories in some cases), an ECC (Error Correcting Code) circuit 107, and a flash interface (flash I/F) 108.

The host interface 101 is connected to the host device (external device) 200 such as a personal computer via a data bus 300, and further connected to the bus 104. The host device 200 and memory system 100 exchange data and the like via the host interface 101.

The memory buffer 102 is connected to the host interface 101, and further connected to the bus 104. The memory buffer 102 receives, via the host interface 101, data transmitted from the host device 200 to the memory system 100, and temporarily holds the data. Also, the memory buffer 102 temporarily holds data to be transmitted from the memory system 100 to the host device 200 via the host interface 101.

The CPU 103 controls the operation of the whole memory system 100. The CPU 103 controls all the NAND flash memory chips 110 based on data (instructions or control programs) stored in the volatile memories. More specifically, the CPU 103 reads out control programs (instruction codes) stored in an IROM (Instruction ROM) (not shown) and IRAM (Instruction RAM) (not shown) via the bus 104, decodes the instruction codes, and executes predetermined processes based on the instruction codes. For example, the CPU 103 executes a predetermined process on the NAND flash memory chip 110 in accordance with a command received from the host device 200 in accordance with a control program.

The IROM is a nonvolatile memory, the IRAM is a volatile memory, and each memory stores a pure operation program (an instruction code of the CPU 103) necessary for the CPU to operate.

The instruction table memory 105 is, e.g., a volatile memory, and stores, e.g., instruction codes for accessing the NAND flash memory chips 110. The instruction table memory 105 holds coded sequences (instruction codes) necessary to access the NAND flash memory chips 110.

The FW table memory 106 is connected to the bus 104. The FW table memory 106 is, e.g., a volatile memory, and holds, e.g., control programs to be executed by the CPU 103. More specifically, the FW table memory 106 is used as a temporary buffer for the work of the CPU 103. For example, the FW table memory 106 is a memory for holding, as a temporary buffer, a logical-physical conversion table (to be simply referred to as a table in some cases) for converting a logical address to be accessed from the host device 200 into a physical address, and FW use information.

Note that data to be held in the instruction table memory 105 and FW table memory 106 are stored in the NAND flash memory chips 110. For example, in accordance with a READ command issued by the CPU 103 after the memory system 100 is powered on, various kinds of data are read out from the NAND flash memory chips 110 and supplied to the instruction table memory 105 and FW table memory 106.

The logical-physical conversion table is a table for associating a physical address in a memory cell array 11 of the NAND flash memory chip 110 (to be described later) with a logical address managed by the host device 200. The CPU 103 can convert a logical address supplied from the host device 200 into a physical address by referring to the logical-physical conversion table, and read out data corresponding to the logical address from the NAND flash memory chip 110. The physical address indicates, e.g., information of a physical block address and physical page address.

In this embodiment, the logical-physical conversion table is prepared for each chip. More specifically, logical-physical conversion tables 0 to n are prepared. Logical-physical conversion table 0 is held in chip 0, and physical addresses in chip 0 are set. Similarly, logical-physical conversion table 1 is held in chip 1, and physical addresses in chip 1 are set. However, this is merely an example, and the present embodiment is not limited to this. For example, it is also possible to prepare one logical-physical conversion table for every plurality of chips, or prepare a plurality of logical-physical conversion tables for one chip. Also, each chip holds its own logical-physical conversion table in this embodiment, but the present embodiment is not limited to this, and one chip may hold all logical-physical conversion tables.

The CPU 103 sequentially updates the set contents of the logical-physical conversion tables by, e.g., writing data in and erasing data from the NAND flash memory chips 110.

In this embodiment, the FW table memory 106 holds one logical-physical conversion table. The CPU 103 reads out a new logical-physical conversion table from the NAND flash memory chip 110, and updates the logical-physical conversion table in the FW table memory 106.

Also, in this embodiment, the instruction table memory 105 and the FW table memory 106 will simply be called volatile memories in some cases.

The ECC circuit 107 is connected to the memory buffer 102, instruction table memory 105, and FW table memory 106. The ECC circuit 107 receives write data from the host device 200 via the memory buffer 102, adds an error correcting code to the write data, and supplies the write data having the error correcting code to, e.g., the memory buffer 102 or flash interface 108. Also, the ECC circuit 107 receives data supplied from the NAND flash memory chip 110 via the flash interface 108, performs error correction on the data by using an error correcting code, and supplies the error-corrected data to, e.g., the memory buffer 102, instruction table memory 105, or FW table memory 106.

The flash interface 108 is connected to the ECC circuit 107, bus 104, and instruction table memory 105. Also, the n+1 NAND flash memory chips (chips 0 to n) are connected to the flash interface 108 via a data bus 400. The CPU 103 and firmware (FW) request the flash interface 108 to issue a NAND command to each chip. In response to this request, the flash interface 108 exchanges data with each chip without intervening the CPU 103.

Note that data (e.g., instructions and control programs) to be stored in the instruction table memory 105 and FW table memory 106 are data associated with a basic instruction set, e.g., data necessary to control the NAND flash memory chips 110, or data necessary for the basic operation of the memory system 100. For example, if the data associated with this basic instruction set do not exist in the volatile memories, the memory system 100 cannot respond to a command request from the host device 200.

The data (e.g., instructions and control programs) associated with this basic instruction set are held in the NAND flash memory chips 110. In addition, various instruction sets unique to processes different from the basic instruction set are held in the NAND flash memory chips 110.

### <Overall Arrangement of NAND Flash Memory>

Next, an outline of the arrangement of the NAND flash memory chip 110 according to the embodiment will be explained with reference to FIG. 2. FIG. 2 is a block diagram schematically showing the basic arrangement of the NAND flash memory chip 110 according to the embodiment.

As shown in FIG. 2, the NAND flash memory chip 110 includes the memory cell array 11, a bit line controller 12, a column decoder 13, a data input/output buffer 14, a data input/output terminal 15, a row decoder 16, a control circuit 17, a control signal input terminal 18, and a source line controller 19.

The memory cell array 11 includes a plurality of bit lines BL, a plurality of word lines WL, and a source line SL. The memory cell array 11 includes a plurality of blocks BLK in each of which electrically programmable memory cell transistors (to be also simply referred to as, e.g., memory cells) MT are arranged in a matrix. The memory cell transistor MT has a stacked gate including a control gate electrode and a charge storage layer (e.g., a floating gate electrode), and stores multilevel data in accordance with the change in threshold of the transistor, which is determined by a charge amount injected into the floating gate electrode. The memory cell transistor MT may also have a MONOS (Metal-Oxide-Nitride-Oxide-Silicon) structure in which electrons are trapped in a nitride film.

The bit line controller 12 includes a sense amplifier (not shown) for sensing and amplifying the voltage of the bit line BL in the memory cell array 11, and a data storage circuit (not shown) for latching data to be written. The bit line controller 12 reads out data from the memory cell transistor MT in the memory cell array 11 via the bit line BL, detects the state of the memory cell transistor MT via the bit line BL, and writes data in the memory cell transistor MT by applying a write control voltage to the memory cell transistor MT via the bit line BL.

The column decoder 13 selects the data storage circuit in the bit line controller 12, and outputs data of the memory cell transistor MT, which is read out to the data storage circuit, from the data input/output terminal 15 to the outside (the memory controller 100a) via the data input/output buffer 14.

The data input/output buffer 14 receives data from the data input/output terminal 15, and the received data is stored in the data storage circuit selected by the column decoder 13. Also, the data input/output buffer 14 outputs data outside via the data input/output terminal 15.

The data input/output terminal 15 receives various commands such as write, read, erase, and status read, and addresses, in addition to write data.

The row decoder 16 selects one block BLK and sets other blocks BLK in an unselected state, in a data read, write, or erase operation. That is, the row decoder 16 applies voltages necessary for a read, write, or erase operation to the word lines WL and select gate lines VSGS and VSGD of the memory cell array 11.

The source line controller 19 controls the voltage of the source line SRC.

The control circuit 17 controls the memory cell array 11, bit line controller 12, column decoder 13, data input/output buffer 14, row decoder 16, and source line controller 19. The control circuit 17 includes a boosting circuit (not shown) for boosting the power supply voltage. The control circuit 17 boosts the power supply voltage as needed by the boosting circuit, and applies the boosted voltage to the bit line controller 12, column decoder 13, data input/output buffer 14, row decoder 16, and source line controller 19.

The control circuit 17 controls the operation in accordance with control signals externally input via the control signal input terminal 18, and commands input from the data input/output terminal 15 via the data input/output buffer 14. That is, the control circuit 17 generates desired voltages for data programming, verify, read, and erase in accordance with the control signals and commands, and applies the voltages to the individual units of the memory cell array 11.

### <Outline of Memory>

For example, the memory cell array 11 performs data write and read page by page. As shown in FIG. 3, each page is, a memory space of a set of a plurality of memory cell transistors, and a unique physical address is allocated to the page. Each memory cell transistor MT changes the threshold voltage in accordance with the number of electrons stored in a charge storage layer CS, and stores information corresponding to the threshold voltage. A NAND string is formed by connecting the current paths (sources/drains SD) of the memory cell transistors MT in series, and selection transistors S1 and S2 are connected to the two ends of the NAND string. The other end of the current path of the selection transistor S2 is connected to the bit line BL, and the other end of the current path of the selection transistor S1 is connected to the source line SL.

Word lines WL0 to WL63 extend in the WL direction, and are connected to control gate electrodes CG of a plurality of memory cell transistors MT belonging to the same row. The memory cell transistors MT are formed at the intersections of the bit lines BL and word lines WL. A select gate line SGD extends in the WL direction, and is connected to all selection transistors S2 in the block. A select gate line SGS extends in the WL direction, and is connected to all selection transistors S1 in the block. A plurality of memory cell transistors MT connected to the same word line WL form a page.

As shown in FIG. 4, the memory cell array 11 includes a memory cell array 91 including a plurality of memory cell transistors, and a page buffer 92 for exchanging data with the memory cell transistors. The page buffer 92 holds data of one page. When writing data in the memory cell array 11, the memory controller 100a transmits a write command, a page address indicating the write destination, and write data of one page to the memory cell array 11. The memory cell array 11 stores the write data received from the memory controller 100a in the page buffer 92, and writes the write data in memory cells designated by the page address from the page buffer 92. When starting this write operation to the memory cells, the memory cell array 11 outputs a busy signal indicating that the operation is in progress, to the memory controller 100a. When successively writing data, the same operation as above is performed for the next page address after the busy signal is switched to a ready signal.

When reading out data from the memory cell array 11, the memory controller 100a transmits a read command and a page address indicating the read source to the memory cell array 11. The memory cell array 11 reads out data of one page to the page buffer 92 from memory cells designated by the page address. When staring this read operation from the memory cells, the memory cell array 11 outputs a busy signal to the memory controller 100a. After the busy signal is switched to a ready signal, the readout data stored in the page buffer 92 is output to the memory controller 100a. When successively reading out data, the same operation as above is performed for the next page address.

The memory cell transistor MT can take two or more states having different threshold voltages. That is, the memory cell array 11 can also be configured so that one memory cell can store multilevel data (multi-bit data). In a memory thus capable of storing multilevel data, a plurality of pages are allocated to one word line.

Also, the memory cell array 11 erases data block by block. Each block includes a plurality of pages having consecutive physical addresses. However, the memory cell array 11 is not necessarily limited to a NAND flash memory.

### <Interleave System>

The memory system 100 according to this embodiment adopts a memory interleave system capable of simultaneously programming a plurality of memory chips in parallel.

That is, this interleave system can start programming chip 1 while chip 0 is busy, and then can start programming chip 0 while chip 1 is busy.

### <Operation of Memory System>

The operation of the memory system 100 when the host device 200 successively reads out a plurality of data from the NAND flash memory chips 110 by using the above-described interleave system will be explained below with reference to FIG. 5.

When successively reading out a plurality of data from the NAND flash memory chips 110, the memory system 100 according to this embodiment first determines the addresses of data requested by the host device 200.

Then, the memory system 100 issues a command for reading out data or a logical-physical conversion table from a given NAND flash memory chip 110, and at the same time requests the issue of a NAND command for reading out a logical-physical conversion table corresponding to data to be read out next from another NAND flash memory chip 110, by using the interleave system.

The memory system 100 receives a host command (a command issued by the host is called a host command) and a logical address from the host device 200 via the data bus 300. The CPU 103 sequentially reads out data corresponding to the logical address supplied from the host device 200.

The CPU 103 determines whether the logical address to be read is set in the logical-physical conversion table expanded in the FW table memory 106.

If the CPU 103 determines in step S1002 that the received logical address is not set in the logical-physical conversion table expanded in the FW table memory 106, the CPU 103 determines, by the firmware (FW), a logical-physical conversion table in which the received logical address is set. Then, the CPU 103 determines whether there is a chip from which data or a table is currently being read out, or a chip for which a read operation is scheduled to be performed.

If the CPU 103 determines in step S1003 that there is a chip from which data or a table is currently being read out or a chip for which a read operation is scheduled to be performed, the CPU 103 determines whether this chip is the same as the chip from which a logical-physical conversion table is to be read out. If this chip is the same as the chip from which a logical-physical conversion table is to be read out, the CPU 103 repeats the operation in step S1003.

If the CPU 103 determines in step S1004 that the chip for which a read operation is presently being performed or the chip for which a read operation is scheduled to be performed is not the same as the chip from which a logical-physical conversion table is scheduled to be read out, the CPU 103 requests the flash interface 108 to issue a NAND command for reading out a logical-physical conversion table to the chip for which no read operation is presently being performed and which holds the logical-physical conversion table, and issue a NAND command for reading out data by using the logical-physical conversion table. Consequently, the flash interface 108 issues various NAND commands to the target chip. Meanwhile, the CPU 103 and FW continue step S1011.

If the CPU 103 determines in step S1003 that there is no corresponding chip, the CPU 103 requests the flash interface 108 to issue a NAND command for reading out the logical-physical conversion table to the chip holding the logical-physical conversion table. Consequently, the flash interface 108 issues various NAND commands to the target chip. Meanwhile, the CPU 103 and FW continue step S1011.

If the CPU 103 determines in step S1002 that the received logical address is set in the logical-physical conversion table expanded in the FW table memory 106, the CPU 103 grasps a chip storing the data to be read out. Then, the CPU 103 determines whether there is a chip from which data or a table is currently being read out, or a chip for which a read operation is scheduled to be performed.

If the CPU 103 determines in step S1007 that there is a chip from which data or a table is currently being read out or a chip for which a read operation is scheduled to be performed, the CPU 103 determines whether this chip is the same as the chip from data is to be read out. If this chip is the same as the chip from which data is to be read out, the CPU 103 repeats the determining operation in step S1007.

If the CPU 103 determines in step S1008 that the chip for which a read operation is presently being performed or the chip for which a read operation is scheduled to be performed is not the same as the chip from which data is to be read out, the CPU 103 requests the flash interface 108 to issue a NAND command for reading out the data, by the interleave system. Consequently, the flash interface 108 issues various NAND commands to the target chip. Meanwhile, the CPU 103 and FW continue step S1011.

If the CPU 103 determines in step S1007 that there is neither a chip from which data or a table is presently being read out nor a chip for which a read operation is scheduled to be performed, the CPU 103 requests the flash interface 108 to issue a NAND command for reading out the data. Consequently, the flash interface 108 issues various NAND commands to the target chip. Meanwhile, the CPU 103 and FW continue step S1011.

After the CPU 103 requests the flash interface 108 to issue a read command for the data in steps S1005, S1006, S1009, and S1010, the CPU 103 determines whether the host device 200 has made preparations to issue NAND commands for reading out all data corresponding to the logical addresses supplied from the host device 200. If the CPU 103 determines that the host device 200 has not made preparations to issue NAND commands for reading out all data corresponding to the logical addresses supplied from the host device 200, the process returns to step S1002 even while data or a conversion table is being read out from a chip. If the CPU 103 determines that the host device 200 has made preparations to issue NAND commands for reading out all data corresponding to the logical addresses supplied from the host device 200, the CPU 103 terminates the operation.

### <Functions and Effects of Memory System According to This Embodiment>

When successively reading out a plurality of data, the memory system 100 according to the above-described embodiment reads out data or a logical-physical conversion table from a given NAND flash memory chip 110, and at the same time reads out a logical-physical conversion table corresponding to data to be read out next, from another NAND flash memory chip 110.

This makes it possible to shorten the data output waiting time, and improve the performance of successive read of a plurality of data. Consequently, a plurality of data can rapidly be read out from the memory system 100.

### <Practical Example>

To exhibit the effects of this embodiment, a practical example in which the host device 200 sequentially reads out data A and B from the memory system 100 will be explained below with reference to FIG. 6. (A) in FIG. 6 is a sequence diagram showing the relationship between the host device 200, the memory system 100, and chips, and indicating the practical example according to this embodiment. (B) in FIG. 6 is a sequence diagram showing the relationship between the host device 200, the memory system 100, and chips, and indicating a comparative example according to this embodiment.

The waveform of “Data line 300” shown in FIG. 6 is a waveform indicating the ready/busy state of the memory system 100 when viewed from the host device 200. The waveform of “Chip 0” shown in FIG. 6 is a waveform indicating the ready/busy state of chip 0. The waveform of “Chip 1” shown in FIG. 6 is a waveform indicating the ready/busy state of chip 1.

In this example, physical address A of data A is set in logical-physical conversion table A, and physical address B of data B is set in logical-physical conversion table B. Also, in this example, logical-physical conversion table A and data A are stored in chip 0, and logical-physical conversion table B and data B are stored in chip 1. Furthermore, in this example, logical-physical conversion table A is expanded in the FW table memory 106.

An operation by which the memory system 100 sequentially successively reads out data A and B from the NAND flash memory chips 110 in this case will be explained below.

A practical example according to this embodiment when the host device 200 issues a host command for reading out data A and B to the memory system 100 will be explained with reference to (A) in FIG. 6. Note that the host device 200 supplies logical address A corresponding to data A and logical address B corresponding to data B to the memory system 100 so as to sequentially read out data A and B.

### [Time T0]

At time T0, the CPU 103 performs logical-physical conversion on logical address A, among logical addresses supplied from the host device 200, which corresponds to data A to be read out first. Before that, the CPU 103 determines whether logical address A is contained in a logical-physical conversion table expanded in the FW table memory 106 (step S1002 in FIG. 5).

If the CPU 103 determines that logical address A is contained in the logical-physical conversion table expanded in the FW table memory 106, the CPU 103 converts logical address A into physical address A by using the FW table memory 106 (step S1007 in FIG. 5). Also, the CPU 103 determines whether there is a chip from which data or a table is currently being read out (step S1007 in FIG. 5). If the CPU 103 determines that there is no chip from which data or a table is presently being read out, the CPU 103 requests the flash interface 108 to issue physical address A (Add in (A) in FIG. 6) and a NAND command (Command in (A) in FIG. 6) for setting the data address of data A, to chip 0 having physical address A (step S1010 in FIG. 5).

### [Time T1]

At time T1, the CPU 103 performs logical-physical conversion on logical address B supplied from the host device 200, because no NAND command is issued for physical address B corresponding to logical address B (step S1011 in FIG. 5).

Before that, the CPU 103 determines whether logical address B is contained in the logical-physical conversion table expanded in the FW table memory 106 (step S1002 in FIG. 5).

If the CPU 103 determines that logical address B is not contained in the logical-physical conversion table expanded in the FW table memory 106, the CPU 103 determines whether there is a chip from which data or a table is currently being read out (step S1003 in FIG. 5). If the CPU 103 determines that there is a chip from which data or a table is presently being read out, the CPU 103 determines whether the chip for which a read operation is presently being performed is the same as a chip storing the logical-physical conversion table containing logical address B (step S1004 in FIG. 5). If the CPU 103 determines that the chip for which a read operation is presently being performed is not the same as the chip storing the logical-physical conversion table containing logical address B, the CPU 103 requests the flash interface 108 to issue, to chip 1, a NAND command for setting the table address of logical-physical conversion table B in which logical address B of data B is set, by using the interleave system (step S1005 in FIG. 5).

### [Time T2]

At time T2, the input of the NAND command and physical address A to chip 0 is completed, and the data line between chip 0 and the memory controller 100a is set in the busy state during that.

Thus, when the memory system 100 starts executing a host command, the memory system 100 is set in the busy state when viewed from the host device 200. The memory system 100 is kept in the busy state when viewed from the host device 200, until chip 0 outputs data A to the memory controller 100a. This busy time is the total time of a time during which the FW performs a read (or write) operation, and the busy time between the memory controller 100a and each chip.

### [Time T3]

At time T3, the input of the NAND command and the address of the logical-physical conversion table for converting logical address B to chip 1 is completed, and the data line between chip 1 and the memory controller 100a is set in the busy state.

### [Time T4]

At time T4, physical address A is set in chip 0, and the flash interface 108 issues a NAND command for reading data A based on the request from the CPU 103.

### [Time T5]

At time T5, the address of logical-physical conversion table B is set in chip 1, and the flash interface 108 issues a NAND command for reading out logical-physical conversion table B based on the request from the CPU 103.

### [Time T6]

At time T6, data A is supplied from chip 0 to the memory controller 100a via the data bus 400.

Also, when data A is read out from chip 0, the memory system 100 changes from the busy state to the ready state when viewed from the host device 200.

### [Time T7]

At time T7, logical-physical conversion table B is read out from chip 1 to the memory controller 100a, and set in the FW table memory 106.

### [Time T8]

At time T8, the memory controller 100a reads out data A, and then reads out data B. Consequently, the data line 300 changes to the busy state again until data B is read out.

### [Time T9]

At time T9, the CPU 103 converts logical address B supplied from the host device 200 into physical address B by referring to the FW table memory 106, and the flash interface 108 issues a NAND command for setting the address of physical address B to chip 1 having physical address B.

### [Time T10]

At time T10, the input of physical address B to chip 1 is completed, and the data line between chip 1 and the memory controller 100a is set in the busy state during that.

### [Time T11]

At time T11, the CPU 103 issues a NAND command for reading out data B to chip 1.

### [Time T12]

At time T12, data B is read out from chip 1 to the memory controller 100a. Consequently, the data bus 300 changes from the busy state to the ready state.

As described above, the memory system 100 according to this embodiment can almost simultaneously issue NAND commands to different chips by using the interleave system.

### Comparative Example

Next, the comparative example of this embodiment will be explained with reference to (B) in FIG. 6. In this comparative example, a memory system having no interleave system will be explained. Since the memory system according to the comparative example has no interleave system, neither data nor a read NAND command cannot be issued to a given chip while data or a table is read out from another chip. Accordingly, no read NAND command cannot be issued to a given chip until the execution of a NAND command issued to another chip is completed. As indicated by (B) in FIG. 6, therefore, after one data is read out, processing for the next data is performed. Consequently, when reading out data A and B in (A) and (B) of FIG. 6, the difference between the time required for the memory system 100 according to this embodiment to read out data A and B and the time required for the memory system according to the comparative example to read out data A and B is a time Tx.

As described above, the memory controller 100a according to this embodiment issues a command for loading a logical-physical conversion table from chip 1 while issuing a data read command to chip 0. Therefore, while data is read out from chip 0, logical-physical conversion table B can be read out from chip 1. This makes it possible to reduce the busy time compared to the operation by which logical-physical conversion table B is read out after data A is read out.

Note that in the above-described practical example, the memory controller 100a issues a command for loading a logical-physical conversion table while issuing a data read command. However, the present embodiment is not limited to this, and it is also possible to issue a command for loading a logical-physical conversion table corresponding to data to be read out next while issuing a command for reading out a logical-physical conversion table.

Also, the host device 200 performs the data read operation in the above-described embodiment and practical example. However, the present embodiment is not necessarily limited to this, and this embodiment is also applicable to an operation by which the host device 200 issues a write command to the memory system 100.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A memory system comprising:
a plurality of nonvolatile semiconductor memories configured to hold data, or a conversion table for converting a logical address of the data into a physical address of the data;
a table memory configured to hold the conversion table;
an interface configured to exchange data and a table with the plurality of nonvolatile semiconductor memories based on a command issue request; and
a controller configured to determine, when a logical address is supplied from a host device, whether the logical address is set in the conversion table held in the table memory,
specify another conversion table in which the logical address is set, if the logical address is not set in the conversion table,
request the interface to issue a command for reading out the specified other conversion table, to the nonvolatile semiconductor memory,
read out the other conversion table, and update the conversion table in the table memory to the other conversion table,
convert the logical address into a physical address based on the conversion table held in the table memory, if the logical address is set in the conversion table, or if the conversion table in the table memory is updated to the other conversion table,
request the interface to issue a command for reading out data held at the physical address, to the nonvolatile semiconductor memory corresponding to the physical address, and
determine, if a logical address for which no read command issue is requested exists among logical addresses supplied from the host device, whether the logical address is set in the conversion table held in the table memory, even while the interface is issuing a command for reading out the data or the conversion table from the nonvolatile semiconductor memory.

2. The system according to claim 1, wherein the conversion table holds physical address information of each nonvolatile semiconductor memory.

3. The system according to claim 1, wherein each of the plurality of nonvolatile semiconductor memories holds the conversion table corresponding to the nonvolatile semiconductor memory.

4. The system according to claim 1, wherein the nonvolatile semiconductor memory comprises a NAND flash memory.

5. The system according to claim 1, wherein the table memory comprises a volatile memory.

6. A memory system comprising:
a plurality of nonvolatile semiconductor memories configured to hold data, or a conversion table for converting a logical address of the data into a physical address of the data;
an interface configured to exchange data and a table with the plurality of nonvolatile semiconductor memories based on a command issue request; and
a controller configured to request, while requesting issue of a command for reading out data or a conversion table from the nonvolatile semiconductor memory, issue of a command for reading out a conversion table in which a logical address of data to be read out next is set.

7. The system according to claim 6, further comprising a table memory configured to hold the conversion table,
wherein the controller updates the conversion table in the table memory to the readout conversion table.

8. The system according to claim 7, wherein when a logical address is supplied from the host device, the controller determines whether the logical address is set in the conversion table held in the table memory.

9. The system according to claim 8, wherein the controller specifies another conversion table in which the logical address is set, if the logical address is not set in the conversion table, and
requests the interface to issue a command for reading out the specified other conversion table, to the nonvolatile semiconductor memory.

10. The system according to claim 9, wherein the controller reads out the other conversion table, and updates the conversion table in the table memory to the other conversion table,
converts the logical address into a physical address based on the conversion table held in the table memory, if the logical address is set in the conversion table, or if the conversion table in the table memory is updated to the other conversion table, and
requests the interface to issue a command for reading out data held in the physical address, to the nonvolatile semiconductor memory corresponding to the physical address.

11. The system according to claim 10, wherein if a logical address is supplied from the host device, the controller determines whether the logical address is set in the conversion table held in the table memory, even while the data or the conversion table is being read out from the nonvolatile semiconductor memory.

12. The system according to claim 6, wherein the conversion table holds physical address information of each nonvolatile semiconductor memory.

13. The system according to claim 6, wherein each of the plurality of nonvolatile semiconductor memories holds the conversion table corresponding to the nonvolatile semiconductor memory.

14. The system according to claim 6, wherein the nonvolatile semiconductor memory comprises a NAND flash memory.

15. The system according to claim 7, wherein the table memory comprises a volatile memory.

16. A control method of a memory system comprising a plurality of nonvolatile semiconductor memories configured to hold data, or a conversion table for converting a logical address of the data into a physical address of the data,
a table memory configured to hold the conversion table,
an interface configured to exchange data and a table with the plurality of nonvolatile semiconductor memories based on a command issue request, and
a controller configured to control the nonvolatile semiconductor memories and the table memory,
the method comprising:
causing the controller to determine, when a logical address is supplied from a host device, whether the logical address is set in the conversion table held in the table memory;
causing the controller to specify another conversion table in which the logical address is set, if the logical address is not set in the conversion table;
causing the controller to request the interface to issue a command for reading out the specified other conversion table, to the nonvolatile semiconductor memory;
causing the controller to read out the other conversion table, and update the conversion table in the table memory to the other conversion table;
causing the controller to convert the logical address into a physical address based on the conversion table held in the table memory, if the logical address is set in the conversion table, or if the conversion table in the table memory is updated to the other conversion table;
causing the controller to request the interface to issue a command for reading out data held at the physical address, to the nonvolatile semiconductor memory corresponding to the physical address; and
causing the controller to determine, if a logical address for which no read command issue is requested exists among logical addresses supplied from the host device, whether the logical address is set in the conversion table held in the table memory, even while the interface is issuing a command for reading out the data or the conversion table from the nonvolatile semiconductor memory.
